(19) United States
(12) Patent Application Publication
(10) Pub. No.: US 2014/0104289 A1
(43) Pub. Date: Apr. 17, 2014

(54) COMPRESSOR, DRIVING DEVICE, DISPLAY DEVICE, AND COMPRESSION METHOD

(71) Applicant: Samsung Display Co., Ltd., Yongin-City (KR)

(72) Inventor: Shintaro NAKAYAMA, Yongin-City (KR)

(73) Assignee: Samsung Display Co., Ltd., Yongin-City (KR)

(21) Appl. No.: 14/051,922

(22) Filed: Oct. 11, 2013

(30) Foreign Application Priority Data
Oct. 11, 2012 (JP) 2012-225611

(51) Int. Cl. G09G 5/10; G06T 9/00

(52) U.S. Cl. CPC G09G 5/10; G06T 9/00
USPC 345/545; 382/239

(57) ABSTRACT

A compressor includes a calculation unit configured to receive image data indicating pixel values of a plurality of pixels and to calculate compression ratios of compression processing methods when pixel values of the pixels in a frame are compressed; a selection unit configured to select one of the compression processing methods based on a relation between the calculated compression ratios and a predetermined threshold value; and a compression unit configured to compress and output the pixel values in the frame using the selected compression processing method.

### CROSS-REFERENCE TO RELATED APPLICATIONS

Japanese Patent Application No. 2012-225611, filed on Oct. 11, 2012, in the Japanese Intellectual Property Office, and entitled: “COMPRESSOR, DRIVING DEVICE, DISPLAY DEVICE, AND COMPRESSION METHOD,” is incorporated by reference herein in its entirety.

### BACKGROUND

1. Field

Embodiments relate to a compressor of image data, a driving device including the same, and a display device including the driving device.

2. Description of the Related Art

A frame memory having a capacity determined according to the number of pixels of a display panel and the number of gray scale levels for display is used to drive a display panel. A display panel capable of being applied to a cellular phone, a smart phone, etc., uses high density, miniaturized pixels to improve the display quality of the display panel.

### SUMMARY

An embodiment provides a compressor that includes a calculation unit configured to receive image data indicating pixel values of a plurality of pixels and to calculate compression ratios of compression processing methods when pixel values of the pixels in a frame are compressed; a selection unit configured to select one of the compression processing methods based on a relation between the calculated compression ratios and a predetermined threshold value; and a compression unit configured to compress and output the pixel values in the frame using the selected compression processing method.

In exemplary embodiments, the compressor has image quality information indicating an image quality on compression of each of the compression processing methods, and the selection unit selects one of the compression processing methods based on the image quality information when the relation between the calculated compression ratios and the threshold value satisfies a predetermined condition.

In exemplary embodiments, the selected compression processing method includes a fixed length coding method having a compression ratio satisfying the predetermined condition.

In exemplary embodiments, the selected unit may be configured to select the fixed length coding when none of the other compression processing methods satisfy the predetermined condition.

In exemplary embodiments, there may be at least two compression processing methods in addition to the fixed length coding, each compression processing methods in addition to the fixed length coding output pixel values having different n-bits, where n is an integer less than or equal to a number of bits of the input image data and greater than a number of bits of the fixed length coded compressed data.

In exemplary embodiments, one of the least two compression processing methods in addition to the fixed length coding may be a lossless compression processing method.

In exemplary embodiments, one of the compression processing methods may be a lossless compression processing method.

In exemplary embodiments, one of the compression processing methods may have a predetermined compression ratio, such that the calculation unit does not calculate the compression ratio thereof.

In exemplary embodiments, the compression unit may be configured to output an identifier indicating the selected compression processing method.

An embodiment to provide a driving device that include the compressor, a frame memory configured to store a value output from the compression unit and an identifier indicating the selected compression processing method and having a capacity according to the threshold value, a de-compressor configured to de-compress a value stored in the frame memory using a method based on the identifier, for decoding, and a driving unit configured to drive the pixels based on pixel values obtained by decoding of the de-compressor.

An embodiment is directed to provide a display device that includes the driving device and a display panel having the pixels driven by the driving unit.

An embodiment is directed to provide a compression method that includes receiving image data indicating pixel values of a plurality of pixels to calculate compression ratios of compression processing methods when pixel values of the pixels in a frame are compressed, selecting one of the compression processing methods based on a relation between the calculated compression ratios and a predetermined threshold value, and compressing and outputting the pixel values in the frame using the selected compression processing method.

### BRIEF DESCRIPTION OF THE DRAWINGS

Features will become apparent to those of ordinary skill in the art by describing in detail exemplary embodiments with reference to the attached drawings in which:

FIG. 1 illustrates a block diagram of a display device according to an embodiment;

FIG. 2 illustrates a block diagram of a compressor according to an embodiment;

FIG. 3 illustrates a diagram for describing image quality information according to an embodiment;

FIG. 4 illustrates a diagram for describing a method of calculating a prediction pixel value, according to an embodiment; and

FIG. 5 illustrates a block diagram of a de-compressor according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Embodiments may be embodied in various different forms, and should not be construed as being limited only to the illustrated embodiments. Rather, these embodiments are provided as examples so that this disclosure will be thorough and complete, and will fully convey the concept to those skilled in the art. Accordingly, known processes, elements, and techniques are not described with respect to some of the embodiments. Unless otherwise noted, like reference numerals denote like elements throughout the attached drawings and written description, and thus descriptions will not be repeated.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

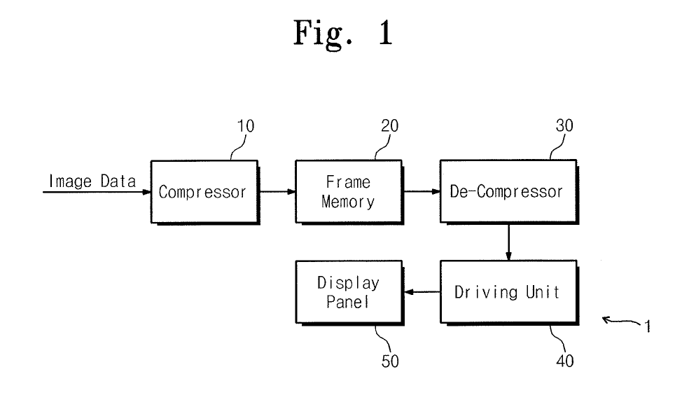

FIG. 1 illustrates a block diagram of a display device 1 according to an embodiment. The display device 1 is a device for displaying an image, e.g., in a smart phone, a cellular phone, a personal computer, a television, etc. The display device 1 may be an organic EL display, a liquid crystal monitor, etc. The display device 1 may include a compressor 10, a frame memory 20, a de-compressor 30, a driving unit 40, and a display panel 50. All or part of the compressor 10, the de-compressor 30 and the driving unit 40 may be implemented by software using a program executed by a central processing unit (CPU) or by hardware.

An image is displayed on the display panel 50 based on image data indicating a pixel value of each pixel. The display panel 50 has a plurality of pixels (e.g., an m×n matrix). In exemplary embodiments, each pixel is formed of sub pixels of three colors, e.g., R (red), G (green), and B (blue). In input image data, a pixel value of each pixel is defined by 24 bits (8 bits per color R/G/B). However, embodiments are not limited thereto. For example, a pixel value of each pixel may be defined by fewer bits (e.g., 18 bits) or by more bits (e.g., 30 bits, 48 bits, etc.).

As illustrated in FIG. 1, image data is compressed by the compressor 10 and the compressed data is stored in the frame memory 20. In exemplary embodiments, in the event that image data is compressed using a compression ratio of more than 50% (the size of data after compression being smaller than a half of the size of data before compression), the frame memory 20 has a capacity capable of storing data of a size corresponding to a frame. Compressed data stored in the frame memory 20 is de-compressed by the de-compressor 30. The driving unit 40 drives the display panel 50 using the de-compressed data and includes a driving circuit for controlling each pixel to show a gray scale according to a pixel value. Thus, an image corresponding to image data is displayed on the display panel 50. Below, the compressor 10 is more fully described.

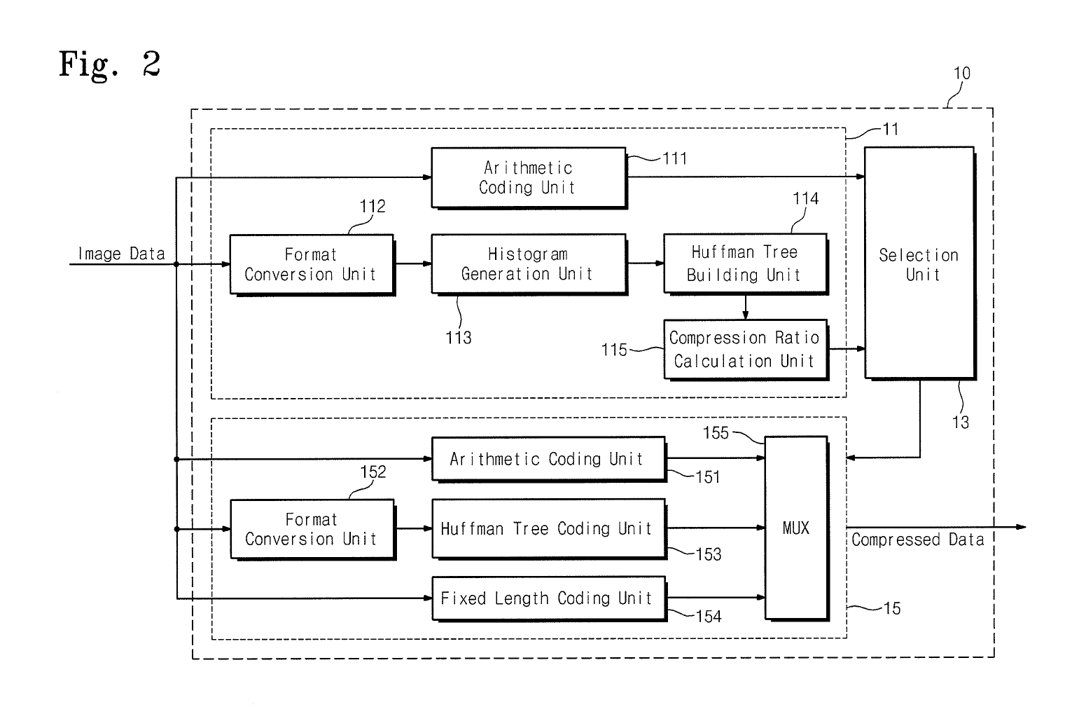

FIG. 2 illustrates a block diagram of the compressor 10 according to an embodiment. The compressor 10 performs a compression operation according to a variety of compression processing methods by a unit of a frame size of image data. At this time, an optimal compression processing method is selected every frame to compress image data, and compressed data is output. In exemplary embodiments, there is output data compressed by a compression processing method, having the best image quality, from among compression processing methods each having a compression ratio of more than 50% from a storable capacity of a frame memory 20.

In exemplary embodiments, the variety of compression processing methods includes five types of compression processing methods: four variable length coding methods and one fixed length coding method. The fixed length coding method is used when a compression ratio of a variable length coding method is less than 50%.

(1) 24-bit pixel value (R: 8 bits, G: 8 bits, B: 8 bits), arithmetic coding (hereinafter, referred to as arithmetic coding (888)), (2) 22-bit pixel value (Y: 8 bits, Pb: 7 bits, Pr: 7 bits), Huffman coding (hereinafter, referred to as Huffman coding (877), (3) 20-bit pixel value (Y: 8 bits, Pb: 6 bits, Pr: 6 bits), Huffman coding (hereinafter, referred to as Huffman coding (866), (4) 21-bit pixel value (Y: 7 bits, Pb: 7 bits, Pr: 7 bits), Huffman coding (hereinafter, referred to as Huffman coding (777), and (5) 12-bit pixel value (R: 4 bits, G: 4 bits, B: 4 bits), fixed length coding (hereinafter, referred to as fixed length coding (444). When a pixel value is YPbPr, it is converted into RGB. The remaining bits except for 24 bits are quantized. Compression processing method (1) has the best image quality, the image quality gradually deteriorating from (1) to (5). The image qualities of the compression processing methods are specified by image quality information. The image quality information may be stored in a memory.

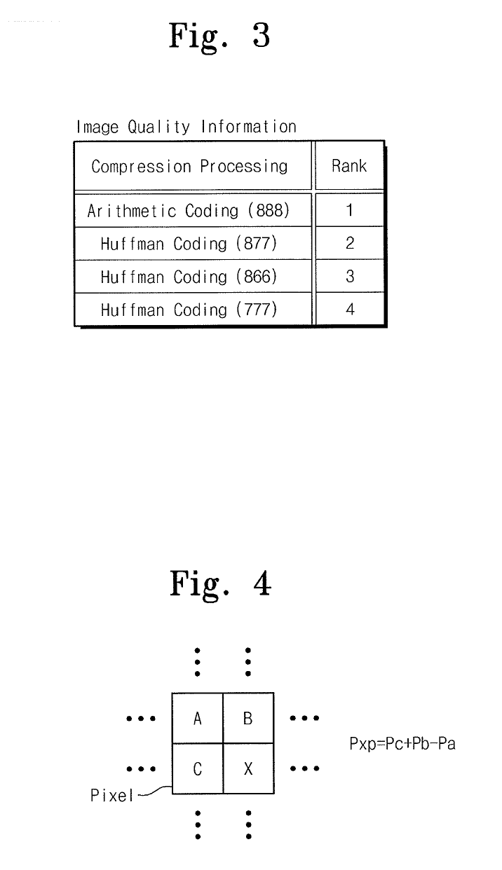

FIG. 3 illustrates a table for describing image quality information according to an embodiment. As shown in FIG. 3, image qualities of compression processing methods after compression are specified according to a superior rank. This rank means that the image quality increases as the number decreases. In exemplary embodiments, the image quality information does not include a rank associated with fixed length coding. The image quality of each compression processing method maybe specified after compression using any information. Embodiments are not limited to the table shown in FIG. 3. Below, a detailed configuration of a compressor 10 is described.

Returning to FIG. 2, the compressor 10 includes a calculation unit 11, a selection unit 13, and a compression unit 15.

When image data is compressed, the calculation unit 11 calculates a compression ratio of each of four compression processing methods (variable length coding) and outputs the calculated compression ratios to the selection unit 13. In exemplary embodiments, also, a compression ratio of the remaining compression processing method, i.e., fixed length coding, is not calculated. The reason is that 24 bits are converted into 12 bits and a compression ratio is set to be 50%.

The calculation unit 11 includes an arithmetic coding unit 111 as a component that is used to calculate a compression ratio of the arithmetic coding (888). The calculation unit 11 may further include a format conversion unit 112, a histogram generation unit 113, a Huffman tree building unit 114, and a compression ratio calculation unit 115 as components that are used to calculate compression ratios of the Huffman coding (877), the Huffman coding (866), and the Huffman coding (777).

The arithmetic coding unit 111 generates a histogram used for the arithmetic coding (888) using a frame of pixel values. At this time, the histogram is generated not using a pixel value itself as a symbol, but using a difference value between an actual pixel value of a compression target pixel and a prediction pixel value as a symbol.

FIG. 4 is a diagram for describing a method of calculating a prediction pixel value, according to an embodiment of the inventive concept. In FIG. 4, a pixel X indicates a compression target pixel, a pixel C indicates a left pixel belonging to the same row, a pixel A indicates a pixel adjacent to the pixel C and belonging to an upper row, and a pixel B is a pixel adjacent to the pixel X and belonging to the upper row. Pixel values of the pixels A, B, C, and X are referred to as Pa, Pb, Pc, and Px, and a prediction pixel value of the pixel X is referred to as Pxp.

For example, the prediction pixel value Pxp of the pixel X may be (Pc+Pb−Pa). In most of an image, a difference between the pixel A and the pixel B is proximate (Px-Pc≈Pb−Pa) to a difference between the pixel C and the pixel X, and likelihood that Px−Pxp≈0 becomes high. In exemplary embodiments, since the histogram is generated using a difference value (Px−Pxp) between an actual pixel value of a compression target pixel and a prediction pixel value as a symbol, a frequency is highly focused around ‘0’ as compared to such a case that a pixel value Px itself is used as a symbol. In other words, the use of the difference value to generate histograms normalizes the image data. Thus, compression having good efficiency may be readily selected.

The prediction pixel value Pxp may be smaller than a minimum value ‘0’ or larger than a maximum value 255 (in case of 8 bits) according to values of pixel values Pa, Pb, and Pc. Here, the prediction pixel value Pxp is set to ‘0’ when it is smaller than the minimum value and to ‘255’ when it is larger than the maximum value. In the event that pixels A, B, and C are placed at an outer side of the display panel 50, the prediction pixel value Pxp may be set to a predetermined pixel value.

Returning to FIG. 2, an arithmetic coding unit 111, also, performs arithmetic coding on the difference value (Px−Pxp) to calculate a compression ratio. The arithmetic coding unit 111 has a function of calculating a compression ratio when compression is performed through the arithmetic coding.

A format conversion unit 112 converts an 8-bit R pixel value, an 8-bit G pixel value and an 8-bit B pixel value of image data into an 8-bit Y format, an 8-bit Pb format, and an 8-bit Pr format.

A histogram generation unit 113 quantizes image data of 8-bit Y, 8-bit Pb and 8-bit Pr according to Huffman coding (877), Huffman coding (866), and Huffman coding (777). That is, each of 8-bit Pb and 8-bit Pr is quantized to 7 bits according to the Huffman coding (877), each of 8-bit Pb and 8-bit Pr is quantized to 6 bits according to the Huffman coding (866), and each of 8-bit Pb and 8-bit Pr is quantized to 7 bits according to the Huffman coding (777).

The histogram generation unit 113 generates histogram from pixel values in a frame of quantized image data. Similar to the arithmetic coding unit 111, the histogram generation unit 113 generates the histogram not using a pixel value itself as a symbol, but using a difference value (Px−Pxp) between an actual pixel value of a compression target pixel and a prediction pixel value as a symbol. Also, a pixel value obtained through quantization on a pixel value of a peripheral pixel is used when the predication pixel value is calculated.

A Huffman tree building unit 114 builds Huffman trees from histograms generated to correspond to the Huffman coding (877), the Huffman coding (866), and the Huffman coding (777). Thus, it is possible to calculate a code length for every symbol.

A compression ratio calculating unit 115 calculates a compression ratio by calculating the size of data after compression. The size of data after compression is calculated by calculating a sum code length obtained by multiplying a symbol frequency, obtained from histogram, and a code length of a symbol with respect to each symbol. In exemplary embodiments, compression ratios of the Huffman coding (877), the Huffman coding (866), and the Huffman coding (777) are calculated, respectively.

A selection unit 13 compares compression ratios of compression processing methods, i.e., a compression ratio of arithmetic coding (888) calculated by the arithmetic coding unit 111 and compression ratios of the Huffman coding (877), the Huffman coding (866), and the Huffman coding (777) calculated by the compression ratio calculating unit 115. Based on the comparison result, the selection unit 13 selects a compression procession method that has a compression ratio satisfying such a condition that it is larger than a predetermined threshold value and has a highest image information rank (or, a good image quality). In the event that a compression ratio is larger than a threshold value regardless of a compression processing method, the selection unit 13 selects fixed length coding the compression ratio of which is fixed to 50%.

The threshold value is predetermined according to a capacity of a frame memory 20. In exemplary embodiments, the threshold value is set to 50%. That is, a compression processing method the compression ratio of which is smaller than 50% (the size of data after compression being larger than 50%) is excluded from a selection target.

For example, if the size of data after compression through the arithmetic coding (888) is 55%, the size of data after compression through the Huffman coding (877) is 48%, the size of data after compression through the Huffman coding (866) is 43%, and the size of data after compression through the Huffman coding (777) is 38%. Since a compression ratio of the arithmetic coding (888) is less than 50% and compression ratios of the Huffman coding (877), the Huffman coding (866), and the Huffman coding (777) are more than 50%, the selection unit 13 discards the arithmetic coding (888 selects from among the Huffman coding (877), the Huffman coding (866), and the Huffman coding (777). Since the Huffman coding (877) has the best image quality, the selection unit 13 selects the Huffman coding (877) as a compression processing method.

A compression unit 15 compresses pixel values in a frame of image data using a compression processing method selected by the selection unit 13. Pixel values of a frame are equal to that used when a compression ratio is calculated. Therefore, although image data is used twice in the compressor 1, i.e., in the calculation unit 11 and the compression unit 15, the image data may be stored in an external memory. Also, a frame may be received iteratively two times. Below, a detailed configuration of the compression unit 15 is described.

The compression unit 15 includes an arithmetic coding unit 151, a format conversion unit 152, a Huffman coding unit 153, a fixed length coding unit 154, and a multiplexer 155.

Similar a format conversion unit 112, the format conversion unit 152 converts a 8-bit R pixel value, a 8-bit G pixel value, and a 8-bit B pixel value of image data into a 8-bit Y format, a 8-bit Pb format, and a 8-bit Pr format.

As described above, each component operates according to a compression processing method selected by the selection unit 13. That is, if a compression processing method selected by the selection unit 13 corresponds to arithmetic coding (888), the arithmetic coding unit 151 compresses image data of a frame corresponding to a target for calculation of a compression ratio and outputs compressed data. If a compression processing method selected by the selection unit 13 corresponds to one of the Huffman coding (877), the Huffman coding (866), and the Huffman coding (777), the Huffman coding unit 153 compresses image data of a frame corresponding to a target for calculation of a compression ratio and outputs compressed data. When a compression processing method selected by the selection unit 13 corresponds to fixed length coding, the fixed length coding unit 154 compresses image data of a frame corresponding to a target for calculation of a compression ratio and outputs compressed data.

The compressed data thus output is stored in a frame memory 20 through the multiplexer 155. At this time, a header including information (an identifier indicating a compression processing method) needed for de-compression is added to every frame.

The arithmetic coding unit 151 compresses image data using the arithmetic coding (888) and outputs compressed data. In detail, similar to the arithmetic coding unit 111, the arithmetic coding unit 151 compresses image data by performing arithmetic coding on a difference value (Px−Pxp) between an actual pixel value of a compression target pixel and a prediction pixel value.

The Huffman coding unit 153 compresses image data using one of the Huffman coding (877), the Huffman coding (866), and the Huffman coding (777) and outputs compressed data. In detail, the Huffman coding unit 153 builds a Huffman tree in the same processing manner as those of the above-described histogram generation unit 113 and Huffman tree calculation unit 114, and compresses image data by performing coding according to a Huffman tree using a difference value (Px−Pxp) between an actual pixel value of a compression target pixel and a prediction pixel value as a symbol.

Whether coding is performed using one of the Huffman coding (877), the Huffman coding (866), and the Huffman coding (777) complies with a compression processing method selected by the selection unit 13.

The fixed length coding unit 154 compresses image data using fixed length coding (444) and outputs compressed data. In detail, the fixed length coding unit 154 performs compression through quantizing of image data, specifying an 8-bit pixel value of each of R, G and B, to a 4-bit value and outputs compressed data.

Thus, the compressor 10 scans each frame of image data twice. First, when pixel values are compressed during first scanning, the compressor 10 calculates compression ratios corresponding to various compression processing methods. Then, the compressor 10 selects a compression processing method having the best image quality from among compression processing methods capable of performing compression suitable for a storable capacity of a frame memory 20, and performs compression using the selected compression processing method every frame during second scanning. Since compression is performed using a compression processing method suitable for contents of an image at every frame, image data is compressed to be suitable for a storable capacity of the frame memory 20 and lowering of the display quality is suppressed. Lossless compression on a frame that has less entropy may be performed using the arithmetic coding (888).

The de-compressor 30 de-compresses compressed data stored in the frame memory 20 using a de-compression processing method corresponding to a compression processing method indicated by information added to a header by compressor 10. The de-compressor 30 outputs a de-compressed pixel value (hereinafter, referred to as a de-compression pixel value) to a driving unit 40. Below, a detailed configuration of the de-compressor 30 is described.

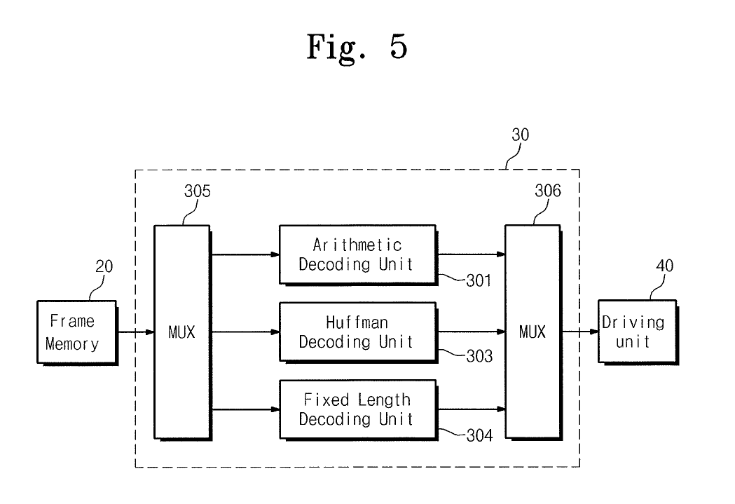

FIG. 5 illustrates a block diagram of the de-compressor 30 according to an embodiment. A de-compressor 30 includes an arithmetic decoding unit 301, a Huffman decoding unit 303, a fixed length decoding unit 304, and multiplexers 305 and 306. The multiplexer 305 outputs compressed data provided from the frame memory 20 to the arithmetic decoding unit 301, the Huffman decoding unit 303, and the fixed length decoding unit 304. The multiplexer 306 outputs a de-compression pixel value from one of the arithmetic decoding unit 301, the Huffman decoding unit 303, and the fixed length decoding unit 304 to a driving unit 40.

When data is compressed using arithmetic coding (888), the arithmetic decoding unit 301 performs de-compression corresponding to compression of an arithmetic coding unit 151 to output a de-compression pixel value. In detail, the arithmetic decoding unit 301 calculates a prediction pixel value of a de-compression target pixel from neighboring pixels of the de-compression target pixel. Neighboring pixels may have the same relation as shown in FIG. 3. When the de-compression target pixel is X, the neighboring pixel indicates pixels A, B, and C on the pixel X. A prediction pixel value is calculated in the same manner as a calculation manner of a compressor 10. However, de-compression pixel values of the pixels A, B, and C are used. The arithmetic decoding unit 301 performs decoding by adding a difference value coded with respect to the de-compression target pixel to a prediction pixel value and outputs a resultant value as a de-compression pixel value.

In the event that data is compressed using one of Huffman coding (877), Huffman coding (866), and Huffman coding (777), the Huffman decoding unit 303 performs decoding by de-compression corresponding to compression of a Huffman coding unit 153 to output a de-compression pixel value. In detail, the Huffman decoding unit 303 calculates a prediction pixel value of a de-compression target pixel from a neighboring pixel of the de-compression target pixel. The Huffman decoding unit 303 performs decoding on a difference value coded with respect to the de-compression target pixel according to a Huffman tree, adds a resultant value of the decoding to a prediction pixel value, and converts an 8-bit value of each of Y, Pb, and Pr into an 8-bit value of each of R, G and B through de-quantization of a resultant value. Finally, the Huffman decoding unit 303 outputs a de-compression pixel value.

If data is compressed using fixed length coding (444), the fixed length decoding unit 304 performs decoding by converting de-compression pixel values corresponding to compression of a fixed length coding unit 154, i.e., a 4-bit value of each of R, G and B into an 8-bit value of each of R, G and B through de-quantization, and outputs a de-compression pixel value. The de-compressor 30 is described before now.

Referring again to FIG. 1, the driving unit 40 uses a de-compression pixel value output from the de-compressor 30. The driving unit 40 drives a corresponding pixel of a display panel 50 to control a gray scale corresponding to the de-compression pixel value. Thus, an image based on image data compressed when stored in a frame memory 20 is displayed on the display panel 50.

In a display device 1 according to an embodiment, since image data is compressed using the above-described compressor 10, lowering of the display quality of an image displayed on the display panel 50 is suppressed and image data is compressed to correspond to a capacity of the frame memory 20.

### First Modified Embodiment

In the above-described embodiment, the selection unit 13 selects a compression processing method having the best image quality from among compression processing methods each having a compression ratio of more than 50%, based on image quality information. However, the image quality information may not be used. For example, a compression processing method may be selected based on a relation between a calculated compression ratio and a threshold value. For example, a compression processing method the compression ratio of which is more than 50% or approximate to 50% may be selected.

### Second Modified Embodiment

In the above-described embodiment, arithmetic coding is the only lossless compression noted. However, Huffman coding may be used to realize lossless compression and arithmetic coding may provide lossy compression. Also, Golomb coding, other variable length coding, etc., may be applied to a compression processing method selected by the selection unit 13.

The number of compression processing methods to be selected by the selection unit 13 is four in above embodiments. However, the number of compression processing methods to be selected by the selection unit 13 may be less or more than four, e.g., more than two. Also, either one of the arithmetic coding and the Huffman coding may not be used.

### Third Modified Embodiment

In the above-described embodiment, a compression ratio when all pixels of a frame are compressed is calculated. However, a compression ratio when only certain pixels of a frame is compressed may be calculated. Also, the compression ratio may be roughly calculated. In this case, a margin is predetermined not to exceed a storable capacity of the frame memory 20 and a compression ratio may be set to be larger than a threshold value.

### Fourth Modified Embodiment

In the above-described variable length coding, histograms are generated using a difference value between an actual pixel value and a prediction pixel value as a symbol. However, a symbol for generating histogram is not limited to the difference value. The symbol may be variously decided.

By way of summation and review, one or more embodiments are directed to providing a compressor, a driving device, a display device, and a compression method that allows image data to be compressed according to a compression ratio larger than a predetermined level while suppressing lowering of the display quality. In particular, by selecting the compression processing method providing the highest image quality in consideration of the capacity of the frame memory, compressed images may be properly stored while improving display quality.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A compressor, comprising:
a calculation unit configured to receive image data indicating pixel values of a plurality of pixels and to calculate compression ratios of compression processing methods when pixel values of the pixels in a frame are compressed;
a selection unit configured to select one of the compression processing methods based on a relation between the calculated compression ratios and a predetermined threshold value; and
a compression unit configured to compress and output the pixel values in the frame using the selected compression processing method.

2. The compressor as claimed in claim 1, wherein:
the compressor has image quality information indicating an image quality on compression of each of the compression processing methods, and
the selection unit selects one of the compression processing methods based on the image quality information when the relation between the calculated compression ratios and the threshold value satisfies a predetermined condition.

3. The compressor as claimed in claim 2, wherein the selected compression processing method comprises a fixed length coding method having a compression ratio satisfying the predetermined condition.

4. The compressor as claimed in claim 3, wherein the selected unit is configured to select the fixed length coding when none of the other compression processing methods satisfy the predetermined condition.

5. The compressor as claimed in claim 3, wherein there are at least two compression processing methods in addition to the fixed length coding, each compression processing methods in addition to the fixed length coding output pixel values having different n-bits, where n is an integer less than or equal to a number of bits of the input image data and greater than a number of bits of the fixed length coded compressed data.

6. The compressor as claimed in claim 5, wherein one of the least two compression processing methods in addition to the fixed length coding is a lossless compression processing method.

7. The compressor as claimed in claim 1, wherein one of the compression processing methods is a lossless compression processing method.

8. The compressor as claimed in claim 1, wherein one of the compression processing methods has a predetermined compression ratio, such that the calculation unit does not calculate the compression ratio thereof.

9. The compressor as claimed in claim 1, wherein the compression unit is configured to output an identifier indicating the selected compression processing method.

10. A driving device, comprising:
a compressor as claimed in claim 1;
a frame memory configured to store a value output from the compression unit and an identifier indicating the selected compression processing method and having a capacity according to the threshold value;
a de-compressor configured to de-compress a value stored in the frame memory using a method based on the identifier, for decoding; and
a driving unit configured to drive the pixels based on pixel values obtained by decoding of the de-compressor.

11. A display device, comprising:
a driving device as claimed in claim 10; and
a display panel having the pixels driven by the driving unit.

12. A compression method, comprising:
receiving image data indicating pixel values of a plurality of pixels to calculate compression ratios of compression processing methods when pixel values of the pixels in a frame are compressed;
selecting one of the compression processing methods based on a relation between the calculated compression ratios and a predetermined threshold value; and
compressing and outputting the pixel values in the frame using the selected compression processing method.
